(19) United States
(12) Patent Application Publication
(10) Pub. No.: US 2012/0284022 A1
(43) Pub. Date: Nov. 8, 2012

(54) NOISE REDUCTION SYSTEM USING A SENSOR BASED SPEECH DETECTOR

(76) Inventor: Alon Konchitsky, Santa Clara, CA (US)

(21) Appl. No.: 13/552,384

(22) Filed: Jul. 18, 2012

Related U.S. Application Data
(63) Continuation-in-part of application No. 12/833,918, filed on Jul. 9, 2010.
(60) Provisional application No. 61/224,643, filed on Jul. 10, 2009.

(51) Int. Cl. G10L 15/00

(52) U.S. Cl. 704/231; 704/E15.001

(57) ABSTRACT

Speech detection is a technique to determine and classify periods of speech. In a normal conversation, each speaker speaks less than half the time. The remaining time is devoted to listening to the other end and pauses between speech and silence. Embodiments of the current invention provide systems and methods that may be implemented in a communication device. A system may include one or more sensors for detecting information corresponding to a user. The user is in a state of verbal communication. The system further includes one or more sensors for determining periods of speech and non-speech, in the verbal communication, based on the detected information and the audio signal captured by the microphones. The determined periods of speech and non-speech may be used in the coding, compression, noise reduction and other aspects of signal processing.

### RELATED PATENT APPLICATION

This utility patent application is a CIP or continuation in part application to U.S. patent application Ser. No. 12/833,918 filed on Jul. 9, 2010 which in turn claims the benefit, priority date and contents of U.S. patent application No. 61/224,643 filed on Jul. 10, 2009 and entitled “Noise Reduction System Using a Sensor Based Speech Detector” the contents of which are incorporated herein by reference.

### FIELD OF THE INVENTION

The present invention relates to noise reduction techniques and more particularly relates to sensor based speech detection for noise reduction using single or multiple microphone(s).

### BACKGROUND OF THE INVENTION

Voice communication devices such as cell phones, wireless phones, Bluetooth headsets etc have become ubiquitous; they show up in almost every environment. They are used at home, office, inside a car, a train, at the airport, beach, restaurants and bars, on the street, and almost any other venue. As might be expected, these diverse environments have relatively high and low levels of background, ambient or environmental noise.

For example, the background noise is significantly high in a crowded restaurant as compared to a quiet home. If this noise, at sufficient levels, is picked up by the microphone, the intended voice communication degrades and uses up more bandwidth or network capacity than is necessary, especially during non-speech segments in a two-way conversation when a user is not speaking.

For a stress-free communication, background noise has to be reduced. Speech detection is the core of any noise cancellation system. It is the art of detecting the presence of speech activity in noisy audio signals in a communication system. In speech recognition applications, the performance is severely degraded if noise is detected as speech.

Noise suppression systems have evolved over the years. Most of them are based on single microphone spectral subtraction technique described in “Suppression of acoustic noise in speech using spectral subtraction”, S. F. Boll IEEE Trans. Acoustics, Speech, and Signal Processing, vol. 27, no.2, pp. 113-120, 1979. Speech detection is used in many signal processing systems for telecommunications. For example, in the Global System for Mobile communications (GSM), traffic handling capacity is increased by having the speech coders employ speech detectors as part of an implementation of the Discontinuous Transmission (DTX) principle, as described in the GSM specifications.

When speech is absent, noise is estimated and adapted. During a normal telephone conversation, each subscriber speaks less than 50% of the time during the connection. The remaining 50% is allocated for listening, gaps between words, syllables, and pauses. Unfortunately, speech detection is not straightforward. In general, speech signal energy is calculated over short durations of time. The measured energy is then compared with a pre-specified threshold level. A zero crossing detector can also be used. The zero crossing rates are compared to a pre-defined threshold. The audio signal is said to be speech if the measured energy exceeds the threshold, otherwise the duration is declared to be noise or non-speech. The problem lies with the threshold determination due to the fact that different speakers usually speak at different levels in different environments. In addition, improperly classifying speech as noise and noise as speech will adversely affect the performance of a communication system.

Attempts to solve the problem of distinguishing between speech signal from the speaker and background noises have largely been unsuccessful. U.S. Pat. No. 7,120,477 B2 assigned to Huang discusses a personal mobile computing device for improving speech recognition. However, this approach uses a microphone (placed on rotatable antenna). The microphone is directed towards the mouth of the user.

U.S. Pat. No. 7,383,181 B2 assigned to Huang et al discusses using a sensor to detect the movement of jaw, face, muscles etc to separate speech and non-speech regions. However, the invention uses a boom microphone with a thermistor placed in the breath stream to sense the change in temperature. The speech detector accepts input from the microphone in the form of an audio signal. The speech detector further outputs a speech detection signal which is indicative of whether or not a user is speaking. Speech detection decisions are made against the mean and variance of the signals that are computed periodically.

Another patent US 2006/0079291 assigned to Granovetter et al uses a proximity sensor on a mobile phone to detect speech and non-speech regions. However, the proximity sensor consists of a soft, medium filled (with fluid or elastomer) pad designed to contact the user when the user places the phone against their ear.

Some of the other techniques include placing a bone conduction sensor which is pressed into contact with the skin. This setup detects vibrations in the bone. Such systems, however, can be irritating to the user, because of this contact with the skin and can be uncomfortable to wear for long durations. If the bone conduction sensor does not contact with the skin, the performance of the system is highly compromised.

### SUMMARY

In an embodiment, the current invention provides a system including one or more sensors, one or more microphones, and a speech detector. The one or more sensors may detect information corresponding to a user. The user may be in a state of verbal communication. The one or more microphones may capture audio signals corresponding to the verbal communication and surrounding noise. The speech detector may determine periods of speech and non-speech in the verbal communication. The periods of speech and non-speech may be determined based on the detected information and the audio signal captured by the one or more microphones.

In another embodiment, the current invention provides a system including one or more sensors for collecting vibrations and other inputs from a person. The person may be in a state of speaking or non-speaking. Further, the system includes one or more microphones capturing audio signals, from the person and surrounding noise. Furthermore, the system may include a combined speech detector configured to determine periods of speech and non-speech signals based on the audio signals captured by the one or more microphones, and vibrations and other inputs collected by the sensors. The system further includes a processing system configured to produce an enhanced speech based on the captured audio signals and the determined periods of the speech and non-speech signal.

In yet another embodiment, the current invention includes a method. The method may include detecting information corresponding to a user. The user may be in a state of verbal communication. Further, the method includes capturing audio signals corresponding to the verbal communication and surrounding noise. The method further includes determining periods of speech and non-speech in the verbal communication, the period of speech and non-speech determined based on the detected information and the captured audio signals.

The current invention relates to speech detection and noise cancellation. Specifically, in an embodiment, the current invention relates to capturing and analyzing multi-sensory input signals and generating an output signal indicating the presence or absence of speech. It provides a novel system and method for monitoring noise in an environment in which a device is operating and detects the presence or absence of speech in noisy environments. This detection is done using the information from single microphone or multi-microphones and a speech sensor which tracks the movement of human tissues, bones, throat, lips etc in the face.

The present invention employs an adaptive system that is operable in high noise conditions. By monitoring the ambient or environmental noise in the location in which the cellular telephone is operating via analog and/or digital signal processing, it is possible to significantly increase the channel bandwidth by identifying the idle regions in a conversation.

In one aspect of the invention, the invention provides a system and method that enhances the convenience of using a cellular telephone, Bluetooth headset, VoIP phone or other wireless telephone or communications device, even in a location having relatively loud ambient or environmental noise.

In another aspect of the invention, the invention provides a system and method that effectively separates the speech and noise regions before the signal is transmitted to the other party.

In yet another aspect of the invention, the proposed system increases the channel bandwidth by effectively identifying the idle regions in a typical conversation.

These and other aspects of the present invention will become apparent upon reading the following detailed description in conjunction with the associated drawings. The present invention overcomes shortfalls in the related art. These modifications, other aspects and advantages will be made apparent when considering the following detailed descriptions taken in conjunction with the associated drawings.

### BRIEF DESCRIPTION OF THE DRAWINGS

Reference will now be made to the accompanying drawings, which are not necessarily drawn to scale, and wherein

FIG. 1 illustrates an exemplary block diagram of an electronic communication device where various embodiments of the invention are implemented;

FIG. 2 illustrates a perspective view of one embodiment of the current invention where the communication device is held on the user's left ear;

FIG. 3A illustrates implementation of a system for noise reduction in accordance with an embodiment of the current invention;

FIG. 3B illustrates the general block diagram of a combined speech detector in a system, in accordance with an embodiment of the current invention;

FIG. 4 illustrates a Bluetooth headset for implementing the system, in accordance with an embodiment of the current invention;

FIG. 5 illustrates a cell phone device for implementing the system, in accordance with an embodiment of the current invention;

FIG. 6 illustrates a cordless phone for implementing a system, in accordance with an embodiment of the current invention;

FIG. 7 illustrates an exemplary block diagram of the proposed system in accordance with an embodiment of the current invention;

FIG. 8 illustrates an exemplary block diagram of the proposed system in accordance with another embodiment of the current invention; and

FIG. 9 illustrates a flow diagram of a method for production of enhanced speech, in accordance with an embodiment of the current invention.

### DETAILED DESCRIPTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

The present invention provides a novel and unique background noise or environmental noise reduction and/or cancellation feature for a communication device such as a cellular telephone, wireless telephone, cordless telephone, Bluetooth headsets, recording device, a handset, and other communications and/or recording devices. While the present invention has applicability to at least these types of communications devices, the principles of the present invention are particularly applicable to all types of communication devices, as well as other devices that process or record speech in noisy environments such as voice recorders, dictation systems, voice command and control systems, and the like.

For simplicity, the following description employs the term “telephone” or “cellular telephone” as an umbrella term to describe the embodiments of the present invention, but those skilled in the art will appreciate the fact that the use of such “term” is not considered limiting to the scope of the invention, which is set forth by the claims appearing at the end of this description.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

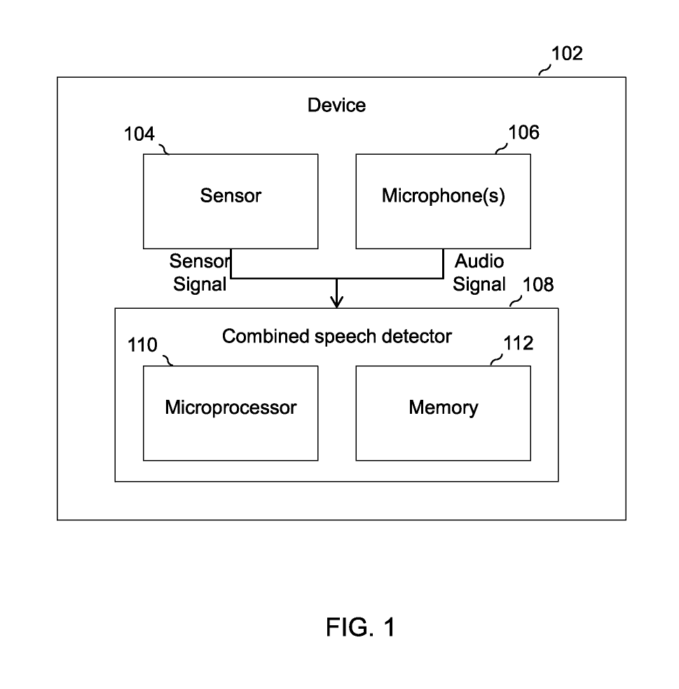

FIG. 1 illustrates an exemplary block diagram of an electronic communication device where various embodiments of the invention are implemented. Herein, FIG. 1 illustrates an electronic communication device 102 that may be used for establishing communication between any two users of such electronic communication devices.

Examples of the electronic communication device 102 may include, but are not limited to cellular telephone, wireless telephone, cordless telephone, Bluetooth headsets, recording device, a handset, and other communications and/or recording devices. Hereinafter, the electronic communication device 102 will be referred to as device 102.

Further, in one embodiment of the present invention, the device 102 may be a Personal Digital Assistant (PDA) or a handheld portable computer that may be available with suitable cellular and phone capabilities and may be able to perform both conventional PDA functions and serve as a wireless telephone.

In another embodiment of the present invention, the device 102 may be a handheld cordless phone. In yet another embodiment of the present invention, the device 102 may be a handheld cellular phone. In yet another embodiment of the present invention, the device 102 may be a Bluetooth headset and the like.

Further, FIG. 1 illustrates that device 102 may constitute a sensor 104, one or more microphones 106 and a combined speech detector 108. Furthermore, the combined speech detector 108 may consist of a microprocessor 110 and a memory 112.

Further, in one embodiment of the present invention, the device 102 may be used to establish a wireless communication channel between two or more handheld devices. Furthermore, in another embodiment of the present invention, the device 102 may be used to establish a communication channel between a desktop computer and/or a laptop using any suitable communication link and a suitable protocol. In an embodiment, the device 102 may be able to establish connection with a laptop using a Bluetooth channel.

Further, the device 102 may implement a system for reducing noise at the sender's side before transmitting an audio signal from sender's side to receiver's end. As shown, the device may include a sensor 104. The sensor 104, herein, may refer to a speech sensor that may be capable of detecting an audio input from the user of the device 102. The sensor 104 referred to herein may cover a variety of sensors and/or transducers that may be capable of providing an output that may be indicative of the fact whether or not a user is speaking.

In an embodiment of the present invention, the sensor 104 may act as an optic sensor acting as transducer that may translate mouth/cheek/skin vibrations to voice signal. Herein, the sensor 104 is capable of detecting the presence or absence of speech from the user of the device 102. Further, the sensor 104, herein, may track the movement of the lips, neck, jaw, facial tissues and other body parts and translate these movements to voice signal accordingly.

Further, in an embodiment, the device may include plurality of sensors that may be implemented in combination to receive inputs from various body movements and associated vibrations to detect periods of speech. For example, the plurality of sensors may include, but are not limited to, a speech sensor and an optic sensor that may be used to detect periods of speech through, but not restricted to, audio input, facial movement, throat movement, jaw movement, head movement and various biological vibrations.

Further, the device 102 may also consist of one or multiple microphones 106 that may be able to pick analog signals. In an embodiment, the microphone 106 may refer to a transducer that may be capable of converting analog voice signals into digital signals that may be provided as one of the inputs to the combined speech detector 108. Herein, the transducer/microphone 106 may be single or multiple in number. In other words, the communication device 102 may have single microphone or N microphones, where N is greater than 1. Further, in another embodiment, the microphone 106 of the communication device 102 may be a regular audio microphone to pick up microphone signals that may further be converted into digital signal by a separate analog to digital converter.

Further, the combined speech detector 108 may be capable of receiving a sensor signal from the sensor 104 and an audio signal from the microphone(s) 106. Both the signals are received by the combined speech detector 108 and a decision may be made about the audio signal, indicating the presence or absence of speech. Accordingly, the process of background noise removal may be carried out.

Further, the combined speech detector may consist of a microprocessor 110 and memory 112. The microprocessor 110 may include, but is not restricted to, a general purpose Digital Signal Processor (DSP), fixed point or floating point, or a specialized DSP (fixed point or floating point). Examples of DSP may include Texas Instruments (TI) TMS320VC5510, TMS320VC6713, TMS320VC6416 or Analog Devices (ADI) BF531, BF532, 533 etc or Cambridge Silicon Radio (CSR) BlueCore 5 Multi-media (BC5-MM) or BC7-MM or BC3. In general, the WNCM may be implemented on any general purpose fixed point/floating point processor or a specialized fixed point/floating point DSP.

Further, the memory 112 may be a Random Access Memory (RAM) based or FLASH based and can be internal (on-chip) or external memory (off-chip). The instructions reside in the internal or external memory. The microprocessor 110, in this case a DSP, may fetch instructions from the memory 112 and may execute them to determine speech and non speech regions in the audio/digital signal that may be received from the microphone 106. In an embodiment, the determined speech and non speech regions may be utilized further to remove background noise for improving signal to noise ratio of the received signal.

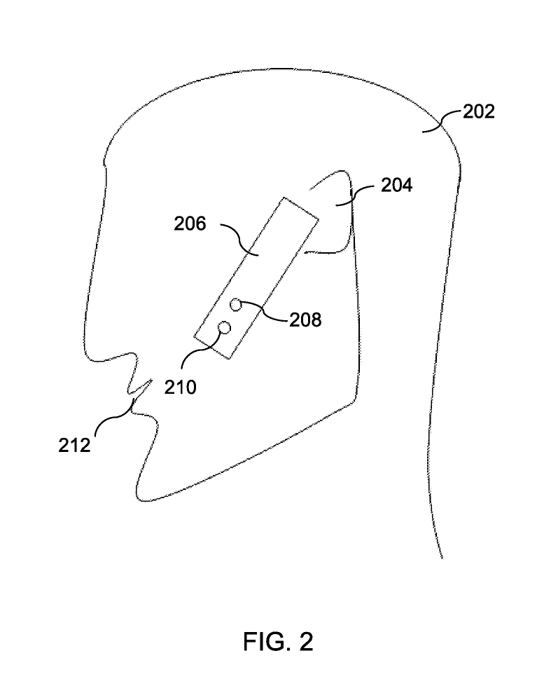

FIG. 2 is a perspective view of one embodiment of the current invention where the communication device, 206 is held adjacent to the user's left ear 204. Herein, when the user speaks, a microphone 210 may receive an audio signal and a sensor detector 208 may receive biological vibrations of the user in the form of sensor signals. Herein, the microphone 210 may refer to a transducer that may be capable of converting analog voice signals into digital signals. Further, the sensor 208 may refer to a speech sensor that may be capable of detecting an audio input from the user of the device 102. The sensor 208 referred to herein may include a variety of sensors and/or transducers that may be capable of providing an output that may be indicative of the fact whether or not the user is speaking.

In an embodiment, the biological vibrations may include, but are not restricted to, vibration in vocal cord, vibrations due to movement of facial tissues, movement in muscles of skull 202, and due to other body vibrations that occur when a user speaks. In another embodiment, the sensor may also act as an optic sensor acting as a transducer that translates mouth/chick/skin vibrations to voice signal.

Further, the sensor 208 may detect presence or absence of speech based on facial movements. Facial movements include, but are not limited to, movements of person's jaw, throat, tissues, bones, and lips. For example, the sensor 208 may detect the presence or absence of speech based on opening and closing of lips 212.

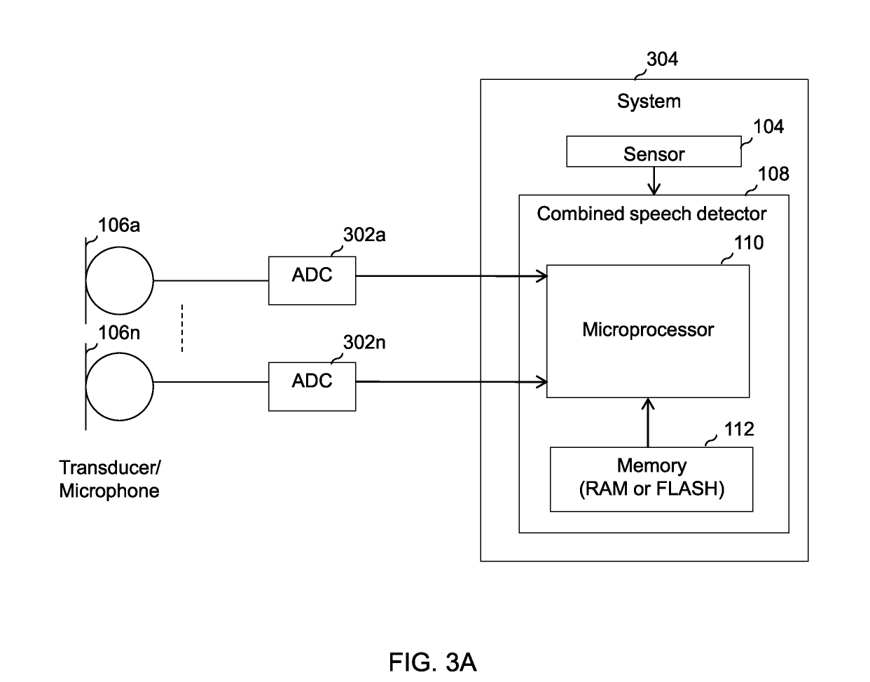

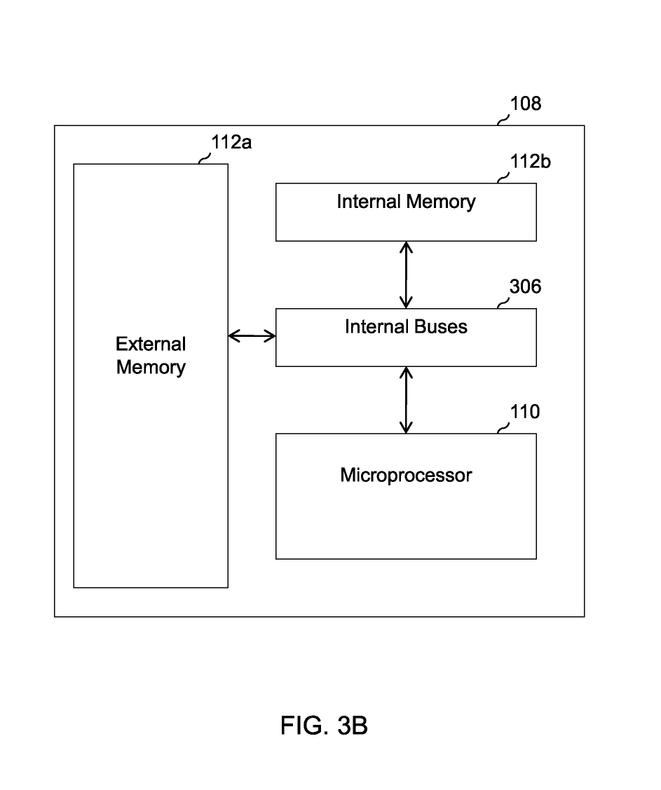

FIG. 3A illustrates implementation of a system for noise reduction in accordance with an embodiment of the current invention. FIG. 3A depicts plurality of microphones (transducers), such as microphones from 106a . . . till 106n. Hereinafter the plurality of microphones may collectively be referred to as ‘microphones 106’. Further, FIG. 3A depicts analog to digital convertor 302a . . . till 302n corresponding to microphones 106a . . . till 106n. Hereinafter each analog to digital convertor may individually be referred to as ‘ADC’ and the analog to digital convertors 302a . . . till 302n may collectively be referred to as ‘ADC 302’. The output from ADC 302 may be transmitted to system 304. In an embodiment, the system 304 includes the sensor 104, and the combined speech detector 108. The combined speech detector may include a microprocessor 110 and a memory 112.

It may be appreciated by a person skilled in the art that the microphone may be single or multiple in number (as shown). The microphone, such as microphone 106a, of the communication device may pick up analog signal when a user of the communication device speaks (i.e. if the user is in verbal communication with another person). The analog signal from each microphone may then be transmitted to the analog to digital convertor (such as ‘ADC 302a’) to convert analog signal into digital signal. As shown, analog signal is transmitted from microphone 106a to ADC 302a. Similarly, the analog signal is transmitted from microphone 106n to ADC 302n. In an embodiment, a microphone may itself convert received analog signal to digital signal.

The digital signal from the ADC 302 may then be sent to the sensor based speech detector such as combined speech detector 108. The combined speech detector 108 receives inputs from ADC 302 and the sensor 104. The input from ADC 302 may be processed by the microprocessor 110 based on the instructions stored in the memory 112.

The microprocessor 110 can be a general purpose Digital Signal Processor (DSP), fixed point or floating point, or a specialized DSP (fixed point or floating point). Examples of DSP include, but are not limited to, Texas Instruments (TI) TMS320VC5510, TMS320VC6713, TMS320VC6416 or Analog Devices (ADI) BF531, BF532, 533 etc or Cambridge Silicon Radio (CSR) BlueCore 5 Multi-media (BC5-MM) or BC7-MM or BC3. In general, the WNCM can be implemented on any general purpose fixed point/floating point processor or a specialized fixed point/floating point DSP.

Further, the memory 112 can be Random Access Memory (RAM) based or FLASH based and can be internal (on-chip) or external memory (off-chip). The memory may include, but is not limited to, instructions that may be executed by the processor to determine a period of speech and non-speech regions in the digital signal. In an embodiment, the memory includes instructions to process the inputs that may be received from the ADC 302 and the sensor 104.

Further, the communication device may include a sensor, such as the sensor 104, to detect the presence or absence of the user's speech. The sensor 104 may track the movement of the lips, neck, jaw, throat, facial tissues and other body parts to determine the presence or absence of the speech. In an embodiment, the sensor 104 collects vibration and other inputs when a user speaks. Examples of biological vibrations may include, but are not limited to, jaw's vibrations, head's vibration, and other facial vibrations. Such biological vibrations may be used to capture speech and to determine periods of speech. Further, in an embodiment, the sensor 104 may also act as an optic sensor acting as transducer that translates mouth/chick/skin vibrations to voice signal. The output of the sensor 104 may be provided to the microprocessor 110 of the combined speech detector 108.

The output of the sensor 104 (that is determination of presence or absence of the speech) and the output of ADC 302 (i.e., the digital signal) are processed by the microprocessor 110 by executing the instructions stored in the memory 112. Based on the processing of the combination of outputs of the sensor 104 and ADC 302, the combined speech detector 108 may determine periods of speech and non-speech in the digital signals. The determined periods of speech and non-speech may further be utilized in the coding, compression, noise reduction and other aspects of signal processing.

FIG. 3B illustrates the general block diagram of a combined speech detector (such as the combined speech detector 108) in a system, such as the system 304, in accordance with an embodiment of the current invention. The system utilizes the combined speech detector 108 for determination of speech and non speech regions in a digital signal when a user speaks.

Specifically, FIG. 3B depicts an embodiment of the system that utilizes the combined speech detector 108. The combined speech detector 108 may receive digital signal as an input from one or more microphones or from one or more Analog to Digital Convertors (as described previously in conjunction with FIG. 3A). Further, the combined speech detector receives an input from a sensor, such as the sensor 104, to determine speech and non-speech regions in the digital signal. The inputs from the microphones (or Analog to Digital Convertor) and the sensor are explained previously in conjunction with FIG. 3A, thus not repeated here for the sake of brevity. The combined speech detector may hereinafter be referred to as a sensor based speech detector.

As shown, the microprocessor 110 is communicably coupled to an external memory 112a and an internal memory 112b through an internal bus 306. Hereinafter, the internal memory 112b and the external memory 112a may collectively be referred to as ‘memory 112’. The microprocessor 110 may utilize instructions that may be stored in the memory 112. The microprocessor 110 may include, but is not limited to, TI TMS320VC5510. Further, those skilled in the art may appreciate the fact that the block 110 may represent a microprocessor, a general purpose fixed/floating point DSP or a specialized fixed/floating point DSP.

The internal memory 112b may include, but is not limited to, SRAM (Static Random Access Memory) and the external memory 112a can be SDRAM (Synchronous Dynamic Random Access Memory). The memory may contain instructions that may be executed by the microprocessor 110 to process the inputs provided to the combined speech detector 108.

The internal buses 306 may include physical connections that may be used to transfer data between the microprocessor 110n and the memory 112. All the instructions required by the combined speech detector 108 may reside in the memory 112 and may be executed by the microprocessor 110 to determine speech and non speech regions in the digital signal.

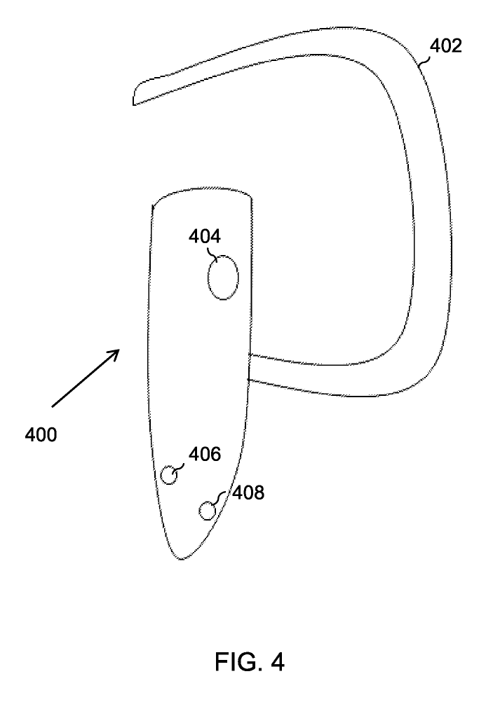

FIG. 4 illustrates a Bluetooth headset 400, with sensor based speech detector, for implementing the system, in accordance with an embodiment of the current invention. The Bluetooth headset may hereinafter be referred to as ‘headset 400’. The headset 400 may include an ear-hook 402, speaker 404, a sensor 406 and a microphone 408. The headset 400 is a device that uses wireless technology to establish communication between two users. When a user speaks, the microphone 408 receives the analog signal that may then be converted into digital signal. Further, the sensor 406 may detect the presence or absence of speech based on various types of facial movements and biological vibrations.

The headset 400 may implement the system to utilize outputs of the sensor 406 and the microphone 408 to determine periods of speech and non-speech of the user of the headset 400. In an embodiment, the periods of speech may include the user's speech time frame and non-speech may include moments of pauses. Further, other outputs signals, such as coughing, sneezing, throat clearing and other auditory sound events, may also be considered as non-speech events. Furthermore, the background noise may also be determined as non-speech event. It may be appreciated by a person skilled in the art that the events such as coughing, sneezing, throat clearing and other similar auditory sound events may have unique characteristics that may be determined as different from voice or silent.

Further, in an embodiment, the device may reduce background noise (or moments of pauses from the digital signal) based on determination of speech and non-speech regions of the digital signal. The determination of speech and non-speech signals is explained previously in conjunction with FIG. 3A, thus not repeatedly explained here for the sake of brevity.

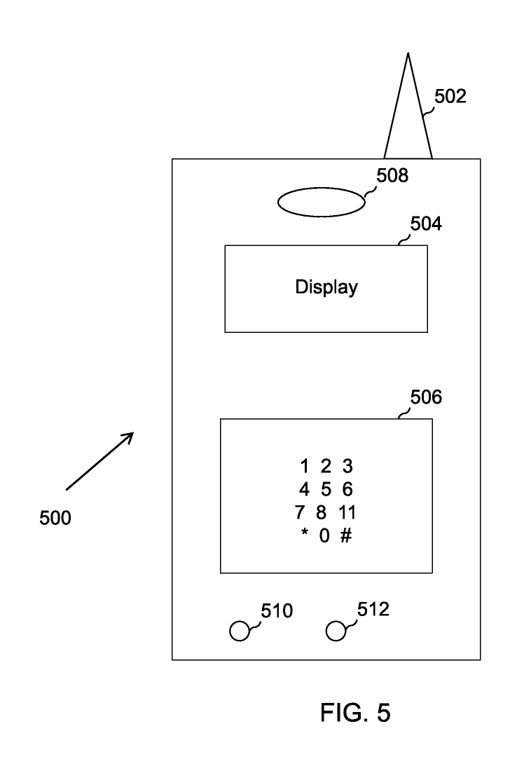

FIG. 5 illustrates a cell phone device 500 for implementing the system, in accordance with an embodiment of the current invention. The cell phone 500 may utilize a sensor based speech detector, such as combined speech detector 108 (as explained previously in conjunction with FIG. 3A). FIG. 5 shows an antenna 502, a display 504, a keypad 506, a loudspeaker 508, a microphone 510 and a sensor 512. When a user speaks, the microphone 510 receives an analog signal that may then be converted into digital signal. Further, the sensor 512 may detect the presence or absence of speech based on various types of facial movements and biological vibrations of a user using the cell phone device 500. The sensor 512 may act as an optic sensor acting as transducer that translates mouth/cheek/skin vibrations to voice signal.

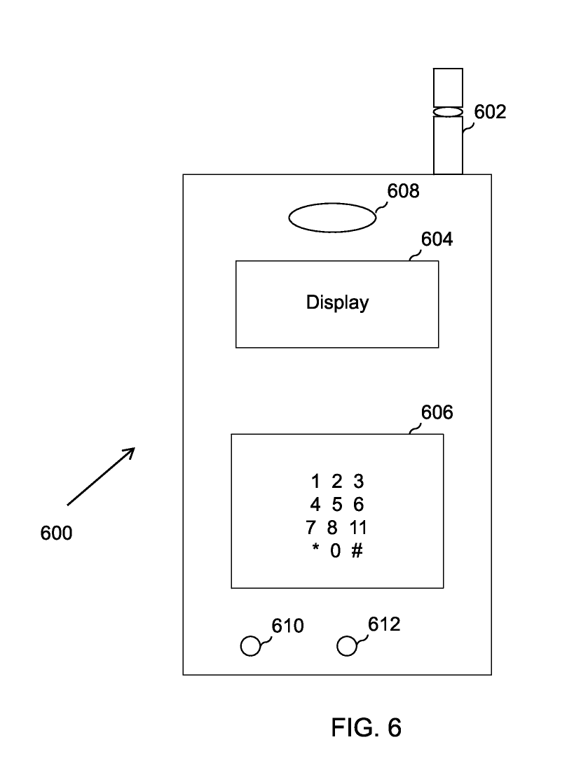

FIG. 6 illustrates a cordless phone 600 for implementing a system, in accordance with an embodiment of the current invention. The cordless phone 600 (as shown) may implement the system, such as the system 304, by utilizing a sensor based speech detector (such as the combined speech detector 108) in a similar way as described for a cell phone device in conjunction with FIG. 5. As shown, the cordless phone 600 includes an antenna 602, a display 604, a keypad 606, a loudspeaker 608, a microphone 610 and a sensor 612. When a user speaks, the microphone 610 receives an analog signal that may then be converted into digital signal. Further, the sensor 612 may detect the presence or absence of speech based on various types of facial movements and biological vibrations of a user using the cordless phone 600. The sensor 612 may act as an optic sensor acting as transducer that translates mouth/cheek/skin vibrations to voice signal.

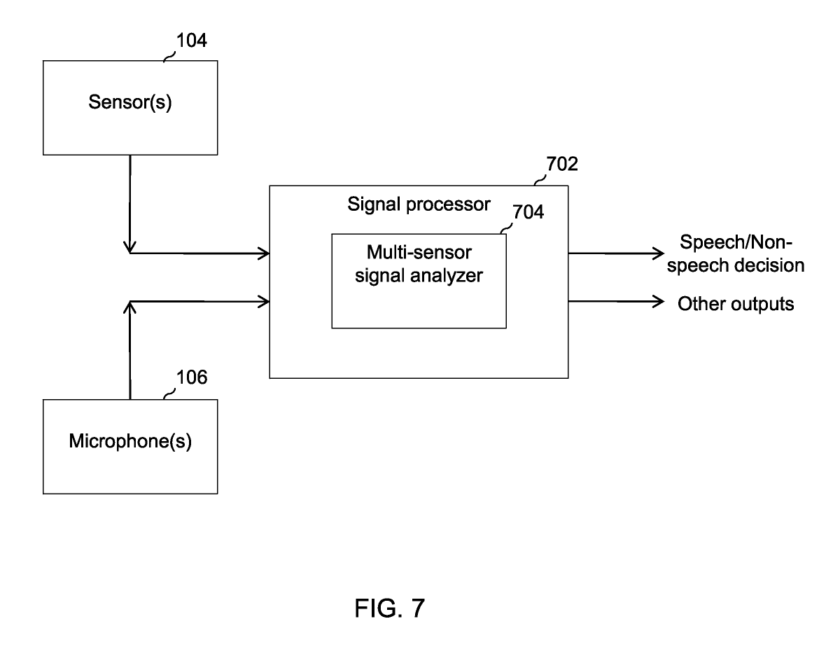

FIG. 7 illustrates an exemplary block diagram of the proposed system in accordance with an embodiment of the current invention. The system may utilize information from one or more sensors and a single or multiple microphone setups. As shown, a signal processor 702 receives inputs from one or more sensors 104 and one or more microprocessors 106. The sensors 104 may track the movement of the lips, neck, jaw, facial tissues and other body parts to determine presence or absence of a user's speech. In an embodiment, the system may include a single sensor to track facial movements and biological vibrations when a user speaks. The sensor can also acts as an optic sensor acting as a transducer that translates mouth/cheek/skin vibrations to voice signal.

Further, the output of the one or more microphones 106 may include an analog signal that may be sent to the signal processor 702. In an embodiment, the output of the microphones 106 may include a digital signal. In another embodiment, the output if the microphones 106 may first be converted into digital signals and then may be sent to the signal processor 702 for further processing of the digital signal. The signal processor 702 may be a digital signal processor that may include a multi-sensor signal analyzer 704 to analyze the analog/digital signals (received from microphones 106) and the output of the sensor 104 to determine speech and non-speech regions of the received analog/digital signals.

The multi-sensor signal analyzer 704 may analyze the inputs received from the sensor 104. The inputs may include, but are not restricted to, various facial movements such as movements of lips, head, jaw etc. and biological vibrations due to the facial movements. In another embodiment, the multi-sensor signal analyzer 704 may receive determination of presence or absence of the speech in the digital/analog signals received from microphones 106. Based on the inputs received from the sensor 104, the multi-sensor analyzer may determine periods of speech and non speech. The periods of speech may signify the time limit for which the user speaks and periods of non-speech may include, but is not restricted to, the moments of pause. In addition to decision regarding periods of speech/non-speech, the signal processor 702 may determine periods of other outputs that may include, but are not restricted to, moments of coughing, sneezing, and throat clearing events that may be a part of the digital/analog signal.

It may be appreciated by a person skilled in the art that in an embodiment of the current invention, the determined periods of speech, non speech and other outputs may be utilized further to remove background noise during the speech periods. Further, the determined periods of non-speech may be utilized by the system to enhance the bandwidth of the system.

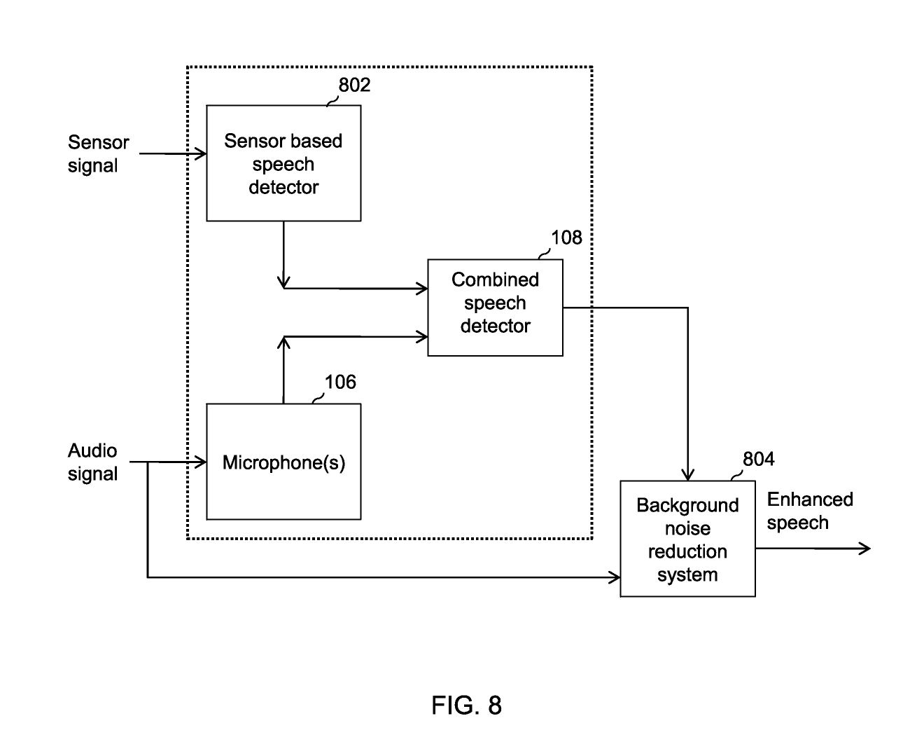

In FIG. 8 illustrates an exemplary block diagram of the proposed system in accordance with another embodiment of the current invention. FIG. 8 shows a sensor based speech detector 802 that receives a sensor signal from a sensor (not shown). The sensor may track the movements in facial muscles, lips, head, and jaw when a user speaks. Further, the sensor may detect various bodily vibrations such as, but are not limited to, face vibrations, jaw vibration, head vibration, throat vibration and other biological vibrations. The sensor signals may include the tracked movements and detected vibrations that may be sent to the sensor based speech detector 802.

The sensor based speech detector 802 may analyze the sensor signals to determine presence or absence of the speech. The output of the sensor based speech detector 802 (i.e., determined presence or absence of the speech) may be provided to a combined speech detector 108. The combined speech detector 108 may further receive inputs from one or more microphones 106 (hereinafter may be referred to as ‘microphones 106’). The microphones 106 receives an audio signal as an input when a user communicates through a device (such as, but not limited to, the Bluetooth device 400, the cell phone 500 and the cordless phone 600, as explained previously in conjunction with FIGS. 4, 5 and 6).

In an embodiment, the microphone converts the audio signal into a digital signal that may then be provided to the combined speech detector 108. Both the inputs (input from the sensor based speech detector 802 and the microphones 106) may be analyzed in combination by the combined speech detector 108 and a decision is made about the audio signal. The decision of the combined speech detector 108 may include, but is not restricted to, determination of periods of speech and non-speech in the audio signal. The period of speech may be determined as a time frame when the user speaks and the period of non speech may be determined as the moments of pause.

In an embodiment, the combined speech detector 108 may detect various events performed by the user while communicating with another user. Such events may be included in the analog signal and may include, but are not limited to, clearing throat, coughing, sneezing, and other auditory sound events.

Further, the output of the combined speech detector 108 may be provided to a background noise reduction system 804. Further, the background noise reduction system 804 may be a processing system that may receive the audio signal as an input. The output of combined speech detector 108 may be utilized by background noise reduction system 804 to reduce background noise, from the audio signal, when the moments of non-speech (or pause) is determined in the audio signal. In an embodiment, the background noise is removed with digital signal processing technologies to produce an enhanced speech.

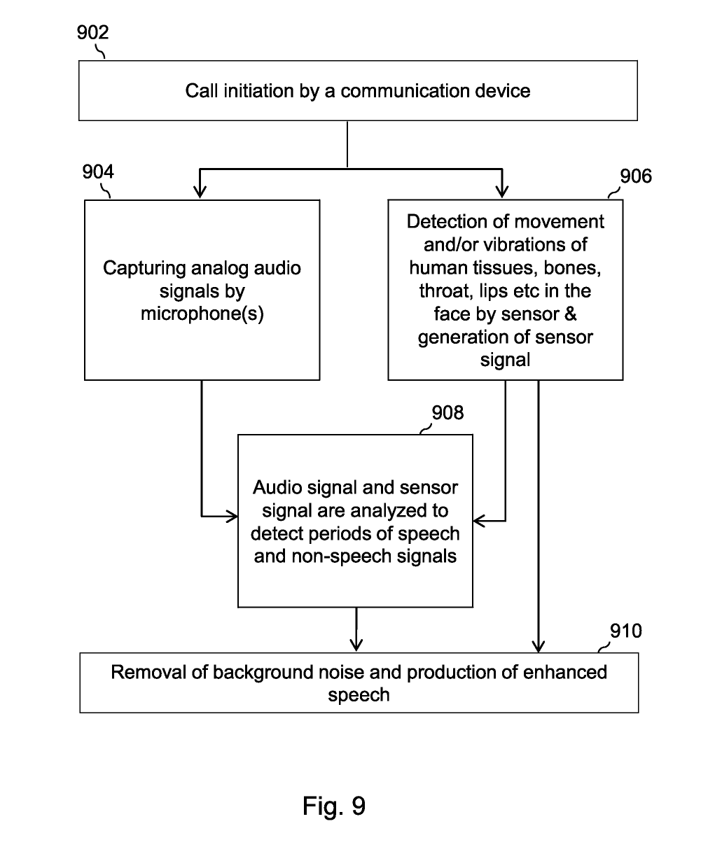

FIG. 9 illustrates a flow diagram of a method for production of enhanced speech, in accordance with an embodiment of the current invention. The method may be implemented by a system, such as the system 304 for enhancing the speech and channel bandwidth by removing background noise from a signal. The order in which the method is performed is not intended to be construed as limitation, and further any number of the method steps may be combined in order to implement the method or an alternative method without departing from the scope of the current invention.

As shown, at step 902, a call may be initiated by a communication device, such as the Bluetooth device 400, the cell phone 500 and the cordless phone 600 (as explained previously in conjunction with FIGS. 4, 5 and 6). For example, a user may give a command to the communication device to initiate the call. Further, at step 904, the microphone(s), such as the microphones 106, of the communication device may detect the presence of an audio input when a user speaks and further the microphones may capture the detected audio signals.

Further, at step 906, movements and corresponding vibrations of human tissues, bones, throat, lips and other facial movements may be detected when the user speaks. The movements and vibrations may be detected by one or more sensors. Based on the detection of the movements and vibrations, sensor signals may be generated. Such sensor signals may be utilized to detect presence or absence of speech.

Further, at step 908, the captured audio signal and sensor signals may be analyzed to detect periods of speech and non-speech signals in the audio signal. The speech signals may include signals when the user speaks and the non-speech signals may include the signals that does not belong to the user's speech, for example, moments of pause. In an embodiment, the background noise may be determined as non-speech signals. Further, in an embodiment, the analysis of the audio signal and the sensor signals may be analyzed to detect other outputs in the audio signals. The other outputs may include, but are not limited to, coughing, sneezing, throat clearing, and other auditory sound events.

Further, based on the detected periods of speech and non-speech signal, the background noise may be removed at step 910. For example, the background noise may be removed from the audio signal for the periods of non-speech signals. In an embodiment, the background noise may be reduced by using DSP technologies. It may be appreciated by a person skilled in the art that bandwidth of the communication channel may be increased by reducing background noise and thereby the speech may be enhanced. The enhanced speech signals may then be transmitted to receiver who is in communication with the user.

It may be appreciated by the person skilled in the art that the current invention is not limited to the above-mentioned embodiments. Further, various other embodiments may also be implemented through the features provided by the system. Also, the usage of terminology such as ‘combined speech detector’, ‘sensor based speech detector’, and the like may not be considered as restrictive aspect of the current invention as such terminologies are used just for the purpose of better explanation of the current invention.

Advantageously, the current invention provides systems and methods that may be implemented in a device to reduce noise using sensor based speech detector. The sensor based speech detector may determine presence or absence of the speech by detecting facial movements and biological vibrations when a user speaks. Such detection of presence or absence of speech may be utilized to reduce the noise. Further, due to reduction of noise, such as background noise, the bandwidth of a communication channel may be increased and this further results in producing an enhanced speech and better communication between the user and a receiver who is in communication with the user.

Further, a crucial component for a successful background noise reduction algorithm is robust speech detection technique. The current invention may be provided for an improved speech detection process with adaptive thresholds and to provide means for detecting low level speech activity in the presence of high level background noise.

Further, it may be appreciated by a person skilled in the art that the invention is not limited to the advantages as mentioned here above. Further many other advantages may be understood in light of the description given above without departing from the scope of the invention. Further, various devices may be utilized to implement the system and the method without restricting to the devices as described in the current invention. For example, in addition to Bluetooth, cell phone, and cordless phone, the current invention may also be utilized in devices such as radio receiver that may play back speech signals. Further, the method and system may be implemented by means of a special hardware, using instructions that may be executed by a microprocessor or by using an integrated circuit.

While the invention has been described with reference to a detailed example of the preferred embodiment thereof, it is understood that variations and modifications thereof may be made without departing from the true spirit and scope of the invention. Therefore, it should be understood that the true spirit and the scope of the invention are not limited by the above embodiment, but defined by the appended claims and equivalents thereof.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

What is claimed is:

1. A system comprising:
a) one or more sensors for detecting information corresponding to a user, the user being in a state of verbal communication;
b) one or more microphones for capturing audio signals corresponding to the verbal communication and surrounding noise;
c) a speech detector configured to determine periods of speech and non-speech in the verbal communication, the periods of speech and non-speech determined based on the detected information and the audio signal captured by the one or more microphones.

2. The system of claim 1, wherein the detected information comprises at least one of facial vibrations, facial movements and other inputs from the user, when the user is in the state of the verbal communication.

3. The system of claim 1 further comprising processing system configured to produce an enhanced speech based on the captured audio signals and the determined periods of speech and non-speech.

4. The system of claim 1, wherein the one or more sensors detect information corresponding to the user when the user is speaking, not speaking, or performing an auditory sound event.

5. The system of claim 4, wherein the speech detector further configured to determine other signals corresponding to the auditory sound event.

6. The system of claim 1, wherein the sensors detect information by receiving inputs from the user, the inputs correspond to movements of or vibrations in at least one of the user's jaw, user's throat, user's face, user's head, and user's lips.

7. The system of claim 1, wherein the speech detector determines periods of speech based on at least one of user's face vibrations, jaw vibrations, throat vibrations, head vibrations and other biological vibrations.

8. A system comprising:
a) one or more sensors for collecting vibrations and other inputs from a person, the person being in a state of speaking or non-speaking;
b) one or more microphones capturing audio signals, from the person and surrounding noise;
c) a combined speech detector configured to determine periods of speech and non-speech signals based on the audio signals captured by the one or more microphones, and vibrations and other inputs collected by the sensors; and
d) a processing system configured to produce an enhanced speech based on the captured audio signals and the determined periods of the speech and non-speech signal.

9. The system of claim 8, wherein the one or more sensors further configured to detect information corresponding to the person when the person is speaking, not speaking or performing an auditory sound event.

10. The system of claim 9, wherein the combined speech detector further configured to determine other signals corresponding to the auditory sound event.

11. The system of claim 8, wherein the sensors collect vibrations and other inputs from the person by detecting movements of or vibrations in at least one of the user's jaw, user's throat, user's face, user's head, and user's lips.

12. The system of claim 8, wherein the combined speech detector determines the periods of speech based on at least one of person's face vibrations, jaw vibrations, throat vibrations, head vibrations and other biological vibrations.

13. The system of claim 8, wherein the processing system produces the enhanced speech by removing background noise from the audio signal based on the determined periods of the speech and non-speech signals.

14. A method comprising:
detecting information corresponding to a user, the user being in a state of verbal communication;
capturing audio signals corresponding to the verbal communication and surrounding noise; and
determining periods of speech and non-speech in the verbal communication, the period of speech and non-speech determined based on the detected information and the captured audio signals.

15. The method of claim 14, wherein the detected information comprises at least one of biological vibrations, facial movements and other inputs from the user, when the user is in the state of the verbal communication.

16. The method of claim 14 further comprising producing an enhanced speech based on the captured audio signals and the determined periods of speech and non-speech.

17. The method of claim 14, wherein the information corresponding to the user being detected when the user is in a state of speaking, not speaking, or performing an auditory sound event.

18. The method of claim 14 further comprising determining other signals corresponding to the auditory sound event based on the detected information and the captured audio signals.

19. The method of claim 14, wherein the information being detected by receiving inputs from the user, the inputs correspond to movements of or vibrations in at least one of the user's jaw, user's throat, user's face, user's head, and user's lips, when the user speaks in the state of verbal communication.

20. The method of claim 14, wherein the periods of speech and non-speech being determined based on at least one of user's face vibrations, jaw vibrations, throat vibrations, head vibrations, other biological vibrations, and moments of pause.
